(19) United States
(12) Patent Application Publication
(10) Pub. No.: US 2008/0136733 A1
(43) Pub. Date: Jun. 12, 2008

(54) Modular antenna panel

(76) Inventors: Lynn Ann DeRose, Gloversville, NY (US); Nicolas Schieli, Montreal (CA); Joseph James Salvo, Schenectady, NY (US); Morgan Fredric Intrator, Wilmington, NC (US); Janet Sue Bennett, Scotia, NY (US); Douglas Roy Forman, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/634,642

(22) Filed: Dec. 6, 2006

(51) Int. Cl. H01Q 1/50; H01Q 1/12

(52) U.S. Cl. 343/878; 343/906

(57) ABSTRACT

Disclosed is a modular antenna panel including an antenna wire disposed in a panel substrate, and also including one or more electrical connectors and one or more mechanical connectors disposed at one or more edges of the modular antenna panel. The electrical connectors are configured for electrical connectivity with adjacent modular antenna panels and the mechanical connectors are configured to enable mechanical connections with adjacent modular antenna panels. Two or more modular antenna panels can be arranged to form an antenna assembly for a radio frequency identification system. Adjacent modular antenna panels are electrically connected to one another by engaging one or more of the electrical connectors disposed at one or more edges of the adjacent modular antenna panels, and are mechanically connected to one another by engaging one or more of the mechanical connectors disposed at one or more edges of the adjacent modular antenna panels.

### BACKGROUND

The present invention relates to radio frequency identification (RFID) systems, and specifically to a modular antenna panel for an RFID system.

The purpose of an RFID system is to enable data to be transmitted by a mobile device, called a tag, which is read by an RFID reader and processed according to the needs of a particular application. The data transmitted by the tag may provide identification or location information, or specifics about the product tagged, such as price, color, date of purchase, etc.

In a typical RFID system, individual objects are equipped with a small, inexpensive tag. The tag contains a transponder with a digital memory chip that may be given a unique electronic product code. The interrogator, an antenna packaged with a transceiver and decoder, emits a signal activating the RFID tag so it can read and perhaps write data to it. When an RFID tag passes in proximity to the antenna, it detects the reader's activation signal. The reader decodes the data encoded in the RFID tag's chip and the data is passed to the host computer. The application software on the host computer processes the data, and may perform various filtering operations to reduce the numerous often redundant reads of the same tag to a smaller and more useful data set.

Depending on the application, the antenna may be configured to fit entryways, dock doors, bay doors, or perhaps constructed as stand-alone cubes. Currently, each application requires a custom designed, built, and installed antenna to fit the particular entryway, dock door, etc. The custom nature of the antenna makes the build and install processes time consuming and costly. What is needed is a solution that reduces the customization of the antenna based on the application, which in turn reduces lead time and cost associated with design, build, and installation of the antenna.

### BRIEF DESCRIPTION

Embodiments of the invention solve one or more of the aforementioned challenges through a modular antenna panel comprising an antenna wire disposed in a panel substrate. The modular antenna panel includes one or more electrical connectors disposed at one or more edges of the modular antenna panel, the electrical connectors configured for electrical connectivity with adjacent modular antenna panels. To enable mechanical connection to adjacent modular antenna panels, the modular antenna panel includes one or more mechanical connectors disposed at one or more edges of the modular antenna panel configured to enable mechanical connections with adjacent modular antenna panels.

Other embodiments of the invention provide two or more modular antenna panels arranged to form an antenna assembly for a radio frequency identification system. Adjacent modular antenna panels are electrically connected to one another by engaging one or more of the electrical connectors disposed at one or more edges of the adjacent modular antenna panels. Adjacent modular antenna panels are also mechanically connected to one another by engaging one or more of the mechanical connectors disposed at one or more edges of the adjacent modular antenna panels.

These and other advantages and features will be more readily understood from the following detailed description of preferred embodiments of the invention that is provided in connection with the accompanying drawings.

### BRIEF DESCRIPTION OF THE DRAWINGS

FIG. 1 illustrates two modular antenna panels constructed in accordance with an embodiment of the invention.

FIG. 2 illustrates a hinge assembly of the modular antenna panel of FIG. 1.

FIG. 3 is a cross-section view of a knuckle portion of the hinge of FIG. 2.

FIG. 4 is a schematic view of a rectangular modular antenna panel assembly constructed in accordance with an embodiment of the invention.

FIG. 5 is a schematic view of a cube-shaped modular antenna panel assembly constructed in accordance with an embodiment of the invention.

### DETAILED DESCRIPTION

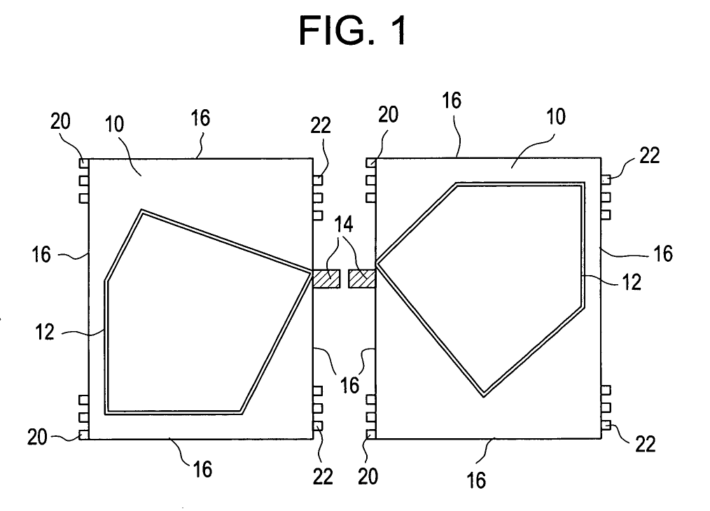

FIG. 1 illustrates two rectangular-shaped modular antenna panels 10. While each modular antenna panel 10 is shown to be substantially rectangular, modular antenna panels 10 may be configured in other shapes as needed to best suit the application. Each modular antenna panel 10 includes an antenna wire 12 and one or more electrical connectors 14 disposed at one or more edge faces 16 of the antenna panel 10. The antenna wire 12 and the electrical connectors 14 are at least partially encapsulated in the modular antenna panel 10.

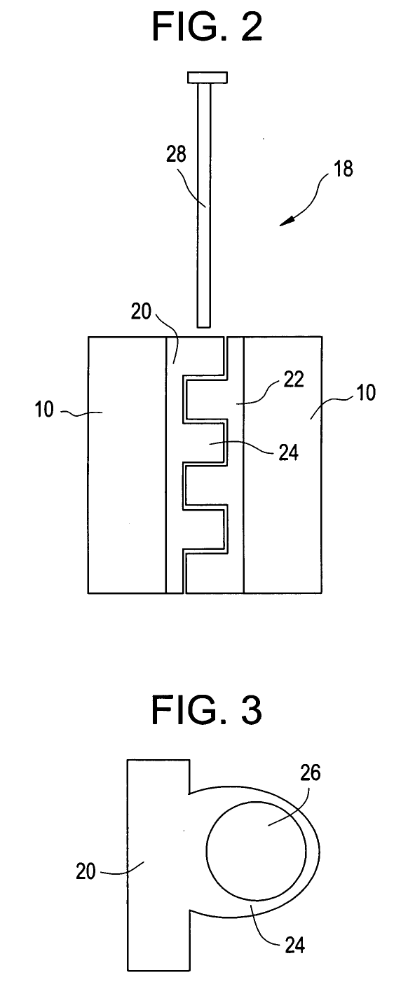

Each modular antenna panel 10 also includes one or more hinge assemblies 18 (FIG. 2). The hinge assemblies 18 are utilized to connect adjacent modular antenna panels 10 and to allow for construction of modular antenna panel assemblies, comprising two or more interconnected modular antenna panels 10, of varying shapes and sizes. The hinge assembly 18 comprises a first hinge bracket 20 mechanically attached to a modular antenna panel 10 and a second hinge bracket 22 mechanically attached to an adjacent modular antenna panel 10. The first hinge bracket 20 includes one or more knuckles 24. As shown in FIG. 3, each knuckle 24 has a through knuckle hole 26, concentric with every other knuckle hole 26 of the first hinge bracket 20. The second hinge bracket 22 also includes one or more knuckles 24. Also as shown in FIG. 3, each knuckle 24 has a through knuckle hole 26, concentric with every other knuckle hole 26 of the second hinge bracket 22. Returning to FIG. 2, the first hinge bracket 20 and the second hinge bracket 22 are configured such that when the adjacent modular antenna panels 10 are in proximity with each other, the knuckles 24 of the first hinge bracket 20 are interleaved with the knuckles 24 of the second hinge bracket 22, and the knuckle holes 26 are concentric. A hinge pin 28 is inserted through the knuckle holes 26 to connect the first hinge bracket 20 to the second hinge bracket 22, and thus connect the adjacent modular antenna panels 10.

As shown in FIG. 1, adjacent modular antenna panels 10 are also electrically connected to each other so current can be provided to the antenna wire 12 in each modular antenna panel 10. The electrical connection is accomplished by connecting an electrical connector 14 of a modular antenna panel 10 to an electrical connector 14 of an adjacent modular antenna panel 10.

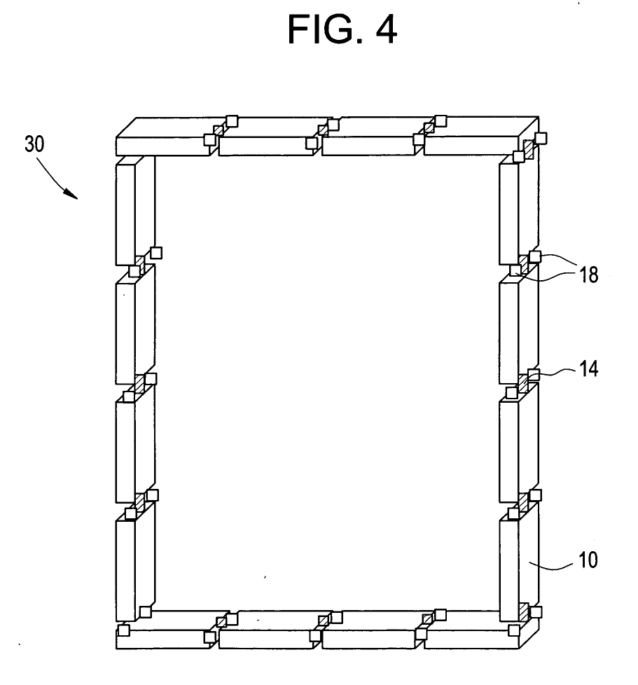

In one embodiment shown in FIG. 4, by using hinge assemblies 18 and electrical connectors 14, individual modular antenna panels 10 are interconnected to form a modular antenna panel assembly 30. The modular antenna panel assembly 30 comprises sixteen modular antenna panels 10 which are arranged into a substantially rectangular shape and interconnected via two hinge assemblies 18 between adjacent modular antenna panels 10 to mechanically connect each modular antenna panel 10 to an adjacent modular antenna panel 10 and an electrical connector 14 between adjacent modular antenna panels 10 to electrically connect each modular antenna panel 10 to an adjacent modular antenna panel 10. The rectangular modular antenna panel assembly 30 may be used, for example, in an entryway or in a warehouse dock doorway.

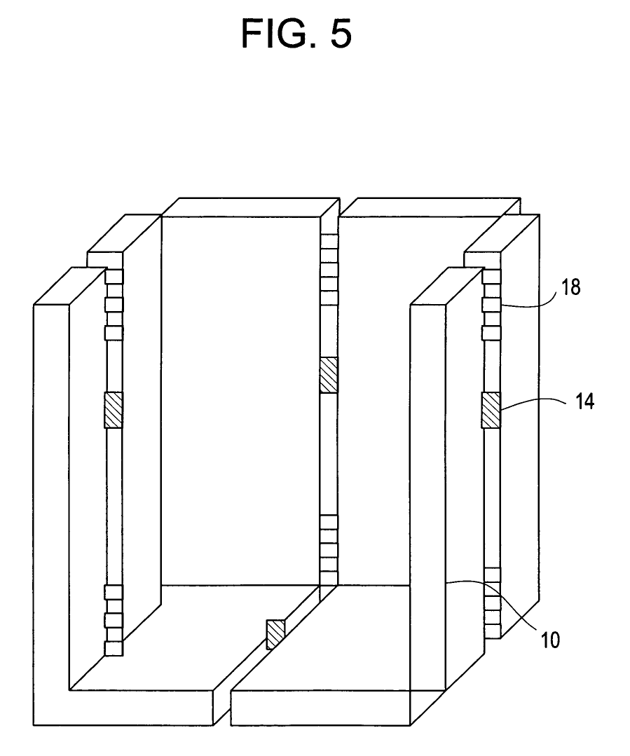

Another example of a modular antenna panel assembly 30 is shown in FIG. 5. The modular antenna panel assembly 30 is configured in a cube shape by utilizing eight modular antenna panels 10. The modular antenna panels 10 are interconnected via two hinge assemblies 18 between adjacent modular antenna panels 10 to mechanically connect each modular antenna panel 10 to an adjacent modular antenna panel 10 and an electrical connector 14 disposed at each of the adjacent modular antenna panels 10 to electrically connect each modular antenna panel 10 to an adjacent modular antenna panel 10.

Modular antenna panels 10 can be interconnected in the manner described to create a modular antenna panel assembly 30 of any size, reducing the need for a custom-designed antenna for each application. Additionally, since the panels are interconnected by simple hinge assemblies 18 and electrical connectors 14, installation time can be reduced, and even those unfamiliar with the technology can install the antenna panel assembly 30 thereby reducing installation time and cost.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A modular antenna panel, comprising:
an antenna wire disposed in a modular antenna panel substrate;
one or more electrical connectors disposed at one or more edges of the modular antenna panel substrate, the electrical connectors configured for electrical connectivity with adjacent modular antenna panels; and
one or more mechanical connectors disposed at one or more edges of the modular antenna panel substrate, the mechanical connectors configured to enable mechanical connections with an adjacent modular antenna panel substrate.

2. The modular antenna panel of claim 1, wherein the one or more mechanical connectors are hinge assemblies.

3. The modular antenna panel of claim 2, wherein each hinge assembly comprises:
a first hinge bracket and a second hinge bracket, the first hinge bracket fastened to an edge of the modular antenna panel substrate and the second hinge bracket being fastenable to an edge of the adjacent modular antenna panel substrate;
one or more knuckles, each including a knuckle hole, disposed on each of the first hinge bracket and second hinge bracket; and
a hinge pin inserted through the knuckle holes of the one or more knuckles of the hinge brackets.

4. The modular antenna panel of claim 3, wherein knuckles of the first hinge bracket interleave knuckles of the second hinge bracket when the first hinge bracket is in proximity to the second hinge bracket, such that each knuckle hole is concentric with each other knuckle hole.

5. The modular antenna panel of claim 1, wherein the modular antenna panel is substantially rectangular-shaped.

6. An antenna assembly for a radio frequency identification system, comprising:
two or more modular antenna panels arranged in a desired configuration, each modular antenna panel including:
an antenna wire disposed in a modular antenna panel substrate;
one or more electrical connectors disposed at one or more edges of the modular antenna panel, the electrical connectors configured for electrical connectivity with adjacent modular antenna panels; and
one or more mechanical connectors disposed at one or more edges of the modular antenna panel substrate, the mechanical connectors configured to enable mechanical connections with an adjacent modular antenna panels substrate;
adjacent modular antenna panels of the two or more antenna panels electrically connected via the one or more electrical connectors; and
adjacent modular antenna panel substrates of the two or more antenna panels mechanically connected via the one or more mechanical connectors.

7. The antenna assembly of claim 6, wherein the one or more mechanical connectors are hinge assemblies.

8. The antenna assembly of claim 7, wherein each hinge assembly comprises:
a first hinge bracket and a second hinge bracket, the first hinge bracket mechanically fastened to an edge of the modular antenna panel substrate and the second hinge bracket configured to be mechanically fastenable to an edge of an adjacent modular antenna panel substrate;
one or more knuckles, each including a knuckle hole, disposed on each of the first hinge bracket and second hinge bracket; and
a hinge pin inserted through the knuckle holes of the knuckles of the first hinge bracket and the second hinge bracket.

9. The antenna assembly of claim 8, wherein the knuckles of the first hinge bracket interleave the knuckles of the second hinge bracket when the first hinge bracket is in proximity to the second hinge bracket, such that each knuckle hole is concentric with each other knuckle hole

10. The antenna assembly of claim 6, wherein the modular antenna panel is substantially rectangular-shaped.

11. The antenna assembly of claim 6, wherein the two or more modular antenna panels are arranged in a rectangular configuration

12. The antenna assembly of claim 6, wherein the two or more modular antenna panels are arranged in a cube-shaped configuration.
